(19) United States
(12) Patent Application Publication
(10) Pub. No.: US 2015/0120049 A1
(43) Pub. Date: Apr. 30, 2015

(54) ROBOT, CONTROL DEVICE, AND ROBOT SYSTEM

(71) Applicant: Seiko Epson Corporation, Tokyo (JP)

(72) Inventor: Masaki MOTOYOSHI, Shiojiri (JP)

(21) Appl. No.: 14/515,876

(22) Filed: Oct. 16, 2014

(30) Foreign Application Priority Data
Oct. 30, 2013 (JP) 2013-225055

(51) Int. Cl. B25J 9/16

(52) U.S. Cl. CPC B25J 9/1602; B25J 9/1628; Y10S 901/09
USPC 700/258; 901/9

(57) ABSTRACT

When a robot in which a first arm is rotatably provided at a base via abase joint portion and the first arm is provided with a first joint portion including a plurality of joints is controlled, a first inertial force is detected on a tip side of the first arm, and a base-side inertial force is detected on a base side of the first arm. The first joint portion of the first arm is controlled on the basis of the base-side inertial force and the first inertial force. If this is the case, since the first joint portion can be controlled using not only the inertial force (first inertial force) on the tip side of the first arm but also the inertial force (base-side inertial force) on the base side of the first arm.

### BACKGROUND

1. Technical Field

The present invention relates to a robot, a control device, and a robot system.

2. Related Art

There have been known robots that mount an arm including a plurality of joints on a trunk portion and attaches a hand portion or the like to a tip of the arm, thereby performing various work. In such robots, work is performed by moving the plurality of joints to deform the arm, thereby moving the hand portion or the like attached to the tip of the arm to a target position. However, since the arm and the hand portion have weight, the tip of the arm vibrates for a while even if the hand portion or the like is moved to and stopped at the target position. For this reason, since work is actually started using the hand portion or the like after the vibration of the arm has settled, it is difficult to improve operating efficiency.

Thus, there is proposed a technology of mounting an inertial sensor on a tip side of the arm and controlling the movement of each joint of the arm so that the output of the inertial sensor becomes small, thereby suppressing the vibration of the arm (JP-A-2010-284770).

However, in the technology proposed above, there is a problem in that the vibration of the arm cannot be sufficiently suppressed and it is difficult to improve the operating efficiency of the robot.

### SUMMARY

An advantage of some aspects of the invention is to provide a technology capable of suppressing the vibration of an arm to thereby improve the operating efficiency of a robot.

A robot according to aspects of the invention has adopted the following configuration.

That is, a robot according to an aspect of the invention includes a base; a first arm that is rotatably provided with respect to the base via a base joint portion and has a first joint portion including a plurality of joints; a base-side inertial sensor that is provided closer to a tip side of the first arm than the base joint portion and closer to a base side of the first arm than the first joint portion and detects an inertial force; a first inertial sensor that is provided closer to the tip side of the first arm than the first joint portion and detects an inertial force; and a controller that controls the first joint portion on the basis of a base-side inertial force detected by the base-side inertial sensor and a first inertial force detected by the first inertial sensor.

According to the configuration, when the plurality of joints (first joint portion) included in the first arm is controlled, not only the first inertial force detected on the tip side of the first arm but also the base-side inertial force detected on the base side of the first arm can be used. Thus, the vibration of the first arm can be sufficiently suppressed and it is possible to improve the operating efficiency of the robot.

In the robot according to the aspect of the invention, the angles of the plurality of joints included in the first joint portion of the first arm may be detected to control the first joint portion as follows. First, a movement speed (first movement speed) of the first arm on the tip side is computed using the angles of the plurality of joints of the first joint portion and the inertial force (base-side inertial force) detected on the base side of the first arm. Additionally, an actual speed (first actual speed) of the first arm on the tip side is computed from the first inertial force detected at the tip of the first arm. The first joint portion may be controlled on the basis of a deviation between the obtained first actual speed and first movement speed.

The deviation between the first actual speed and the first movement speed becomes the cause of vibration of the first arm. Accordingly, if the first joint portion is controlled on the basis of the deviation between the first actual speed and the first movement speed, it is possible to suppress the vibration of the first arm.

In the robot according to the aspect of the invention, the first joint portion may be controlled as follows on the basis of the deviation between the first actual speed and the first movement speed. First, a first strain rate that is a strain rate in the first joint portion is computed on the basis of the deviation between the first actual speed and the first movement speed. The first joint portion may be controlled on the basis of the angles of the plurality of joints of the first joint portions, and the first strain rate.

If the first strain rate is suppressed, it is possible to suppress the vibration of the first arm. Additionally, although will be described below in detail, the influence that the movement of each joint of the first joint portion has on the first strain rate depends on the angle of each joint. Accordingly, if the first joint portion is controlled in consideration of not only the first strain rate but also the angles of the plurality of joints of the first joint portion, it is possible to further suppress the vibration of the first arm.

In the robot according to the aspect of the invention, the first strain rate may be computed by extracting fluctuation components included in the deviation between the first actual speed and the first movement speed.

According to this configuration, since the components that cause the vibration of the first arm can be extracted from the deviation between the first actual speed and the first movement speed, it is possible to further suppress the vibration of the first arm.

In the robot according to the aspect of the invention, the angle of the joint included in the base joint portion may be detected, and a movement speed (base-side movement speed) of the first arm on the base side may be computed on the basis of a change rate of the detected angle. The base joint portion may be controlled on the basis of a deviation between a base-side actual speed obtained from the inertial force (base-side inertial force) actually measured on the base side of the first arm, and the base-side movement speed.

According to this configuration, since the vibration generated on the base-side joint portion can be suppressed, it is possible to further suppress the vibration of the first arm.

In the robot according to the aspect of the invention, a second arm having a second joint portion including a plurality of joints may be rotatably provided at the base via the base joint portion. A second inertial force may be detected by a second inertial sensor provided on the tip side of the second arm, and the second joint portion may be controlled on the basis of a base-side inertial force and the second inertial force.

According to this configuration, it is also possible to suppress the vibration of the second arm for the same reason as that of the first arm.

In the robot according to the aspect of the invention including the second arm, the angles of the plurality of joints included in the second joint portion may be detected to control the second joint portion as follows. That is, a second movement speed of the second arm on the tip side is computed using the angles of the plurality of joints of the second joint portion and a base-side inertial force detected on the base side of the second arm. Additionally, a second actual speed of the second arm on the tip side is computed from the second inertial force detected at the tip of the second arm. The second joint portion may be controlled on the basis of a deviation between the second actual speed and the second movement speed.

The deviation between the second actual speed and the second movement speed becomes the cause of vibrating the second arm. Therefore, if the second joint portion is controlled on the basis of the deviation between the second actual speed and the second movement speed, it is possible to suppress the vibration of the second arm.

The aspect of the invention described above can also be grasped in the form of a control device that controls a robot.

That is, as another aspect of the invention the invention can be grasped as a control device for a robot including a first arm that is rotatably provided with respect to a base via a base joint portion and has a first joint portion including a plurality of joints. The control device includes a base-side inertial sensor that is provided closer to a tip side of the first arm than the base joint portion and closer to a base side of the first arm than the first joint portion and detects an inertial force; and a first inertial sensor that is provided closer to the tip side of the first arm than the first joint portion and detects an inertial force. The control device controls the first joint portion on the basis of a base-side inertial force detected by the base-side inertial sensor and a first inertial force detected by the first inertial sensor.

The aspect of the invention can also be grasped in the form of a control system.

That is, as still another aspect of the invention, the invention can be grasped as a robot system including a robot; and a control device that controls the robot. The robot includes a base; a first arm that is rotatably provided with respect to the base via a base joint portion and has a first joint portion including a plurality of joints; a base-side inertial sensor that is provided closer to a tip side of the first arm than the base joint portion and closer to a base side of the first arm than the first joint portion and detects an inertial force; and a first inertial sensor that is provided closer to the tip side of the first arm than the first joint portion and detects an inertial force. The control device is a control device that controls the first joint portion on the basis of a base-side inertial force detected by the base-side inertial sensor and a first inertial force detected by the first inertial sensor.

With the control device and the robot system of the aspects of the invention, it is also possible to suppress the vibration of the arm to improve the operating efficiency of the robot.

### BRIEF DESCRIPTION OF THE DRAWINGS

The invention will be described with reference to the accompanying drawings, wherein like numbers reference like elements.

FIGS. 1A and 1B are explanatory views illustrating an overall structure of a robot of a first embodiment.

FIG. 2 is an explanatory view illustrating that a controller of the first embodiment transfers data.

FIG. 3 is a block diagram conceptually illustrating an internal configuration of the controller of the first embodiment.

FIGS. 4A to 4D are explanatory views of a first movement speed computing unit of the first embodiment.

FIG. 5 is an explanatory view about a first strain rate computing unit of the first embodiment.

FIGS. 6A to 6D are explanatory views of a first correction rate computing unit of the first embodiment.

FIG. 7 is an explanatory view of a first motor drive unit of the first embodiment.

FIG. 8 is an explanatory view illustrating an operation in which a controller controls a base-side motor.

FIG. 9 is a flowchart of the control processing that the controller executes.

FIG. 10 is an explanatory view illustrating a rough configuration of a robot of a second embodiment.

FIG. 11 is an explanatory view illustrating that a controller of the second embodiment transfers data.

FIG. 12 is a block diagram conceptually illustrating an internal configuration of the controller of the second embodiment.

FIGS. 13A and 13B are explanatory views of a base-side movement speed computing unit of the second embodiment.

FIGS. 14A to 14C are explanatory views of a base-side correction rate computing unit of the second embodiment.

FIG. 15 is an explanatory view illustrating a rough structure of a robot of another aspect of the second embodiment.

FIGS. 16A and 16B are explanatory views illustrating a rough configuration of a robot of a third embodiment.

FIG. 17 is an explanatory view illustrating that a controller of the third embodiment transfers data.

FIG. 18 is a block diagram conceptually illustrating an internal configuration of the controller of the third embodiment.

### DESCRIPTION OF EXEMPLARY EMBODIMENTS

### A. First Embodiment

### A-1. Apparatus Configuration of First Embodiment

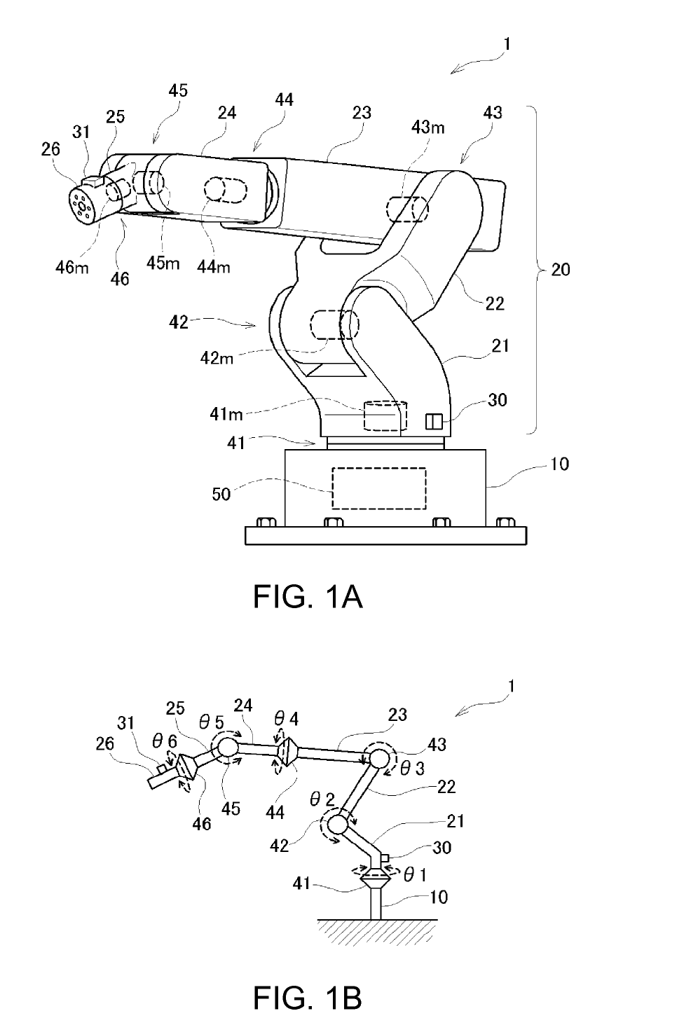

FIGS. 1A and 1B are explanatory views illustrating an overall structure of a robot 1 of a first embodiment. A rough outer shape of the robot 1 of the first embodiment is illustrated in FIG. 1A. As illustrated in the drawing, the robot 1 of the first embodiment has a base 10 that is installed on the ground, a first arm 20 that is rotatably attached to the base 10, and a controller 50 that is mounted in the base 10 and controls the operation of the whole robot 1.

The first arm 20 includes six links 21 to 26 and five joints 42 to 46. The link 21 among these six links is rotatably attached to the base 10 by a joint 41. Additionally, the link 22 is bendably attached to the link 21 by the joint 42, and the link 23 is bendably attached to the link 22 by the joint 43. Moreover, the link 24 is rotatably attached to the link 23 by the joint 44, the link 25 is bendably attached to the link 24 by the joint 45, and the link 26 is rotatably attached to the link 25 by the joint 46. In addition, a robot hand (so-called hand portion), and various kinds of jigs (so-called end effectors) that are not illustrated, such as a welding jig is mounted on a tip of the link 26.

Additionally, a motor 41m for driving the joint 41 is mounted on a portion of the joint 41. Similarly, a motor 42m for driving the joint 42 is mounted on a portion of the joint 42, a motor 43m for driving the joint 43 is mounted on a portion of the joint 43, a motor 44m is mounted on a portion of the joint 44, a motor 45m is mounted on a portion of the joint 45, and a motor 46m is mounted on a portion of the joint 46.

A gyro sensor 30 is attached to the link 21 closest to the base 10 side among the six links 21 to 26, and a gyro sensor 31 is attached to the link 26 closest to the tip side among the six links. Here, the gyro sensors 30 and 31 are sensors capable of outputting angular velocities (or inertial forces) having three predetermined orthogonal axes (an X-axis, a Y-axis, and a Z-axis) as rotational axes. The gyro sensor 30 is attached in an orientation in which the rotational axis of the joint 41 coincides with the Z-axis of the gyro sensor 30. Additionally, the gyro sensor 31 is attached in an orientation in which the rotational axis of the joint 46 coincides with the Z-axis of the gyro sensor 31. In addition, although the present embodiment is described so that the angular velocities are detected as the inertial forces, vector velocities may be detected instead of the angular velocities. Additionally, acceleration sensors may be used instead of the gyro sensors 30 and 31.

The positional relationship between the links 21 to 26, the joints 41 to 46, and the gyro sensors 30 and 31 included in the robot 1 of the first embodiment is typically illustrated in FIG. 1B. In the following, the angle of the joint 41 is represented by an angle θ1, the angle of the joint 42 is represented by an angle θ2, the angle of the joint 43 is represented by an angle θ3, the angle of the joint 44 is represented by an angle θ4, the angle of the joint 45 is represented by an angle θ5, and the angle of the joint 46 is represented by an angle θ6.

In addition, in the first embodiment, the joints 42 to 46 included in the first arm 20 correspond to a “first joint portion” in the invention, and the joint 41 that connects the first arm 20 and the base 10 corresponds to a “base joint portion” in the invention. Additionally, the gyro sensor 30 corresponds to a “base-side inertial sensor” in the invention, and the gyro sensor 31 corresponds to a “first inertial sensor” in the invention. Additionally, in the following specification, the motors 42m to 46m that drive the joints 42 to 46 of the first arm 20 are referred to as “first motors”, and the motor 41m that drives the joint 41 is referred to as a “base-side motor”.

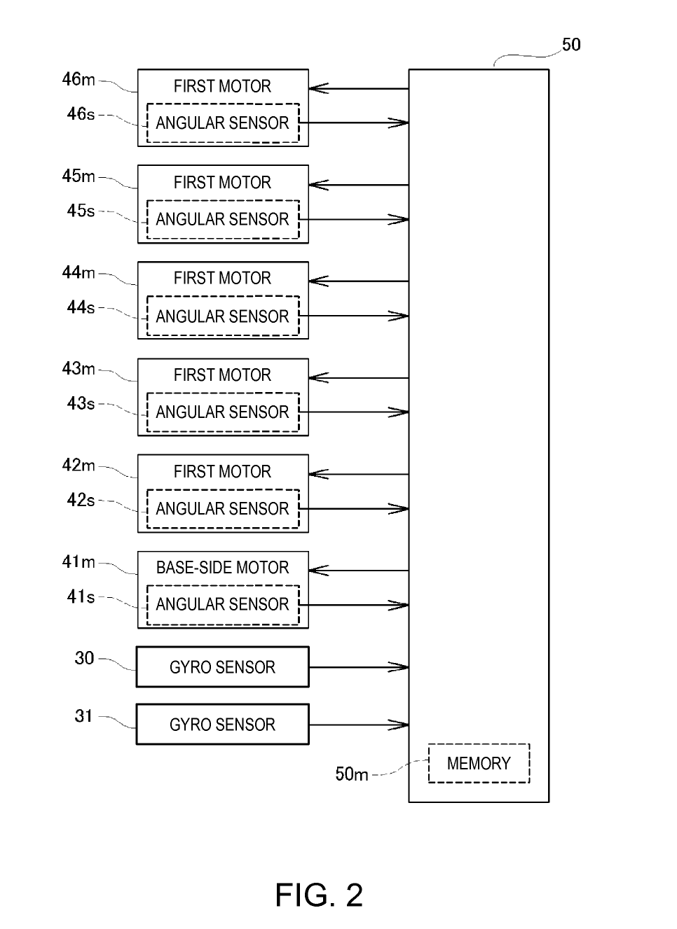

FIG. 2 is an explanatory view illustrating that the motors 41m to 46m and the gyro sensors 30 and 31 transfer data with the controller 50 as a center. An angle sensor 41s that detects the rotational angle of the base-side motor 41m is mounted on the base-side motor 41m. Similarly, angle sensors 42s to 46s that detect the angles θ2 to θ6 are mounted on the first motors (motors 42m to 46m). The output of the angle sensors 41s to 46s and the outputs of the gyro sensors 30 and 31 are input to the controller 50. The controller 50 controls the operation of the base-side motor 41m and the first motors (motors 42m to 46m) on the basis of these outputs. Detailed control contents will be described below. Additionally, various kinds of data referred to during control are stored in a memory 50m built in the controller 50.

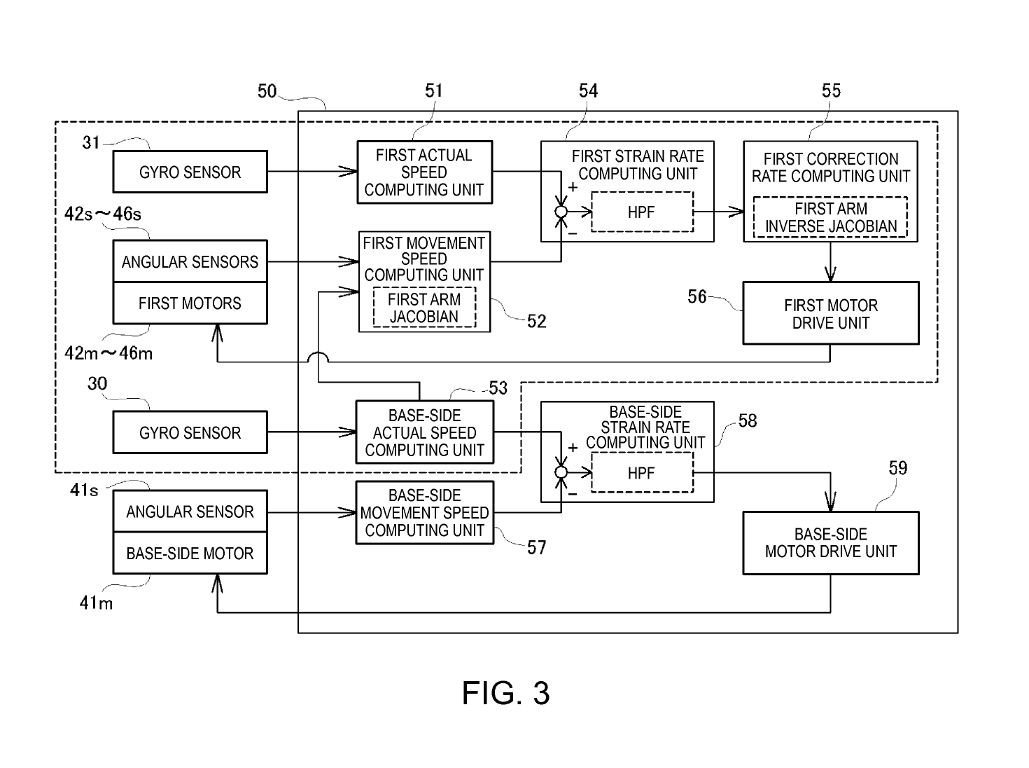

FIG. 3 is a block diagram conceptually illustrating an internal configuration of the controller 50 of the first embodiment. As illustrated in the drawing, the controller 50 of the first embodiment includes a total of nine units of a first actual speed computing unit 51, a first movement speed computing unit 52, a first strain rate computing unit 54, a first correction rate computing unit 55, a first motor drive unit 56, a base-side actual speed computing unit 53, abase-side movement speed computing unit 57, a base-side strain rate computing unit 58, and a base-side motor drive unit 59. In addition, these nine units are provided by classifying the inside of the controller 50 for convenience while paying attention to the functions of the controllers 50 that controls the operation of the motors 41m to 46m, and do not necessarily mean that the controller 50 can be physically divided into nine portions. These nine units can be realized by hardware using LSI or the like and can also be realized by software using a computer program.

Although to be described below in detail, the flow of the data inside the controller 50 can be considered after being largely divided into two flows of a flow of data for controlling the base-side motor 41m and a flow of data for controlling the first motors (motors 42m to 46m). In the flow of data for controlling the base-side motor 41m out of these flows, data are output to the motor 41m after the output of the gyro sensor 30 and the output of the angle sensor 41s are received and predetermined computation is performed inside the controller 50. Additionally, in the flow of data for controlling the first motors (motors 42m to 46m), data are output to the first motors (motors 42m to 46m), respectively, after the output of the gyro sensor 31 and the outputs of the angle sensors 42s to 46s are received, a halfway computation result for the control of the motor 41m is also received, and a predetermined computation is performed inside the controller 50. In the following, the specific contents of computation performed inside the controller 50 of the first embodiment will be described.

### A-2. Control Method of First Embodiment

### A-2-1. First Movement Speed Computing Unit

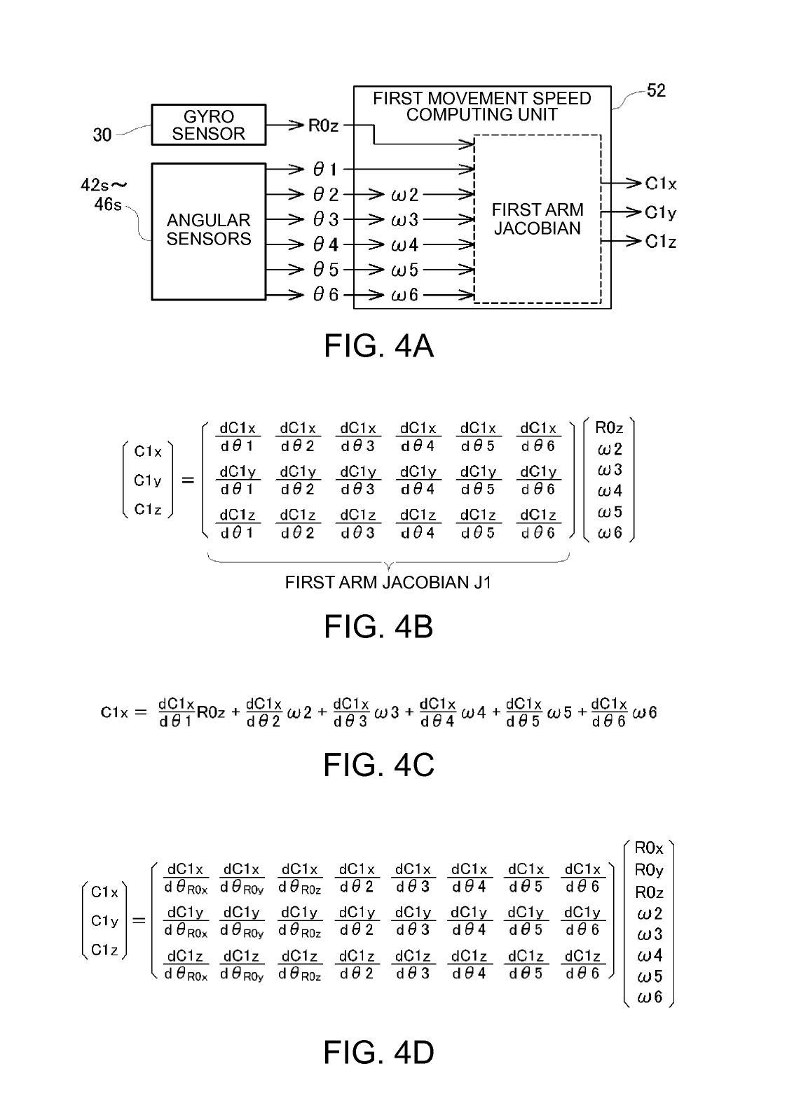

FIGS. 4A to 4D are explanatory views of the contents of computation that the first movement speed computing unit 52 of the controller 50 executes. The first movement speed computing unit 52 computes the movement speed of a tip portion (link 26) of the first arm 20 on the basis of the following principle. First, as illustrated in FIG. 1B, the link 26 is connected to the base 10 via the joints 41 to 45. Accordingly, if the joint 41 is rotated, the link 26 moves together with the links 21 to 25 connected to the base 10. Additionally, the movement speed of the link 26 at this time depends on the rotating speed of the joint 41. Similarly, if the joint 42 is rotated, the position of the link 26 moves together with the links 22 to 25 connected to the link 21, and the movement speed at this time depends on a rotating speed (angular velocity ω2) of the joint 42. Similarly, even the joints 43 to 45 are rotated, the link 26 moves, and the movement speed of the link 26 at this time depend on a rotating speed (angular velocity ω3) of a joint 43, a rotating speed (angular velocity ω4) of the joint 44, a rotating speed (angular velocity ω5) of the joint 45, and a rotating speed (angular velocity ω6) of the joint 46.

Here, since the angle θ2 of the joint 42 can be detected by the angle sensor 42s, the angular velocity ω2 of the joint 42 can be obtained if a differential value (simply, variation) of the output of the angle sensor 42s is calculated. Similarly, the angular velocities ω3 to ω6 can also be obtained from the differential values (simply, variations) of the outputs of the angle sensors 43s to 46s. Additionally, as mentioned above, since the Z-axis of the gyro sensor 30 is attached so as to have the same orientation as the rotational axis of the joint 41, the gyro sensor 30 can obtain an angular velocity by which the joint 41 rotates if an angular velocity R0_{z} of the gyro sensor 30 around the Z-axis is detected.

Accordingly, it is possible to compute the movement speed of the link 26, using the output (angular velocity R0_{z}) of the gyro sensor 30 and the outputs (angles θ2 to θ6) of the angle sensors 42s to 46s provided at the joints 42 to 46 of the first arm 20. In addition, since the link 26 moves three-dimensionally, the movement speed thereof also has three components. Although any coordinate axes may theoretically be used as coordinate axes for the respective components, three orthogonal axes (XYZ axes) of the gyro sensor 31 are used for convenience of control. Accordingly, the movement speed of the link 26 is expressed by respective components (C1ₓ, C1_{y}, and C1_{z}) of the gyro sensor 31 in directions of the X-axis, the Y-axis, and the Z-axis.

The first movement speed computing unit 52 computes the movement speeds (C1ₓ, C1_{y}, and C1_{z}) in a place which the gyro sensor 31 of the link 26 is attached on the basis of the above principle. That is, as illustrated in FIG. 4A, the angular velocity R0ₓ measured by the gyro sensor 30, the angle θ2 of the joint 42 detected by the angle sensor 42s, the angle θ3 of the joint 43 detected by the angle sensor 43s, the angle θ4 of the joint 44 detected by the angle sensor 44s, the angle θ5 of the joint 45 detected by the angle sensors 45s, and the angle θ6 of the joint 46 detected by the angle sensor 46s are acquired. Subsequently, the angles θ2 to θ6 are converted into the angular velocities ω2 to ω6 by computing differential values (or variations per time) of the angles θ2 to θ6. In addition, the angle θ1 of the joint 42 detected by the angle sensor 41s is used in order to compute a Jacobian to be described below. Then, the respective components C1ₓ, C1_{y}, and C1_{z} of the movement speed of the link 26, can be computed by applying a Jacobian to the angular velocity R0_{z} in the joint 41 and the angular velocities ω2 to ω6 in the joints 42 to 46.

A Jacobian (hereinafter referred to as a first arm Jacobian J1) used in order to obtain the movement speeds (C1ₓ, C1_{y}, and C1_{z}) of the link 26 is illustrated in FIG. 4B. Here, the outline of the meaning of the first arm Jacobian J1 will be described. For example, attention will be paid to the X component C1ₓ of the movement speed of the link 26. As mentioned above, the movement speed of the link 26 depends on the angular velocity R0_{z} in the joint 41 and the angular velocities ω2 to ω6 in the joints 42 to 46. Accordingly, the X component C1ₓ of the movement speed can also be expressed in the form as illustrated in FIG. 4C by the linear combination of the angular velocity R0_{z} and the angular velocities ω2 to ω6. Here, a coefficient (dC1ₓ/dθ1) pertaining to the angular velocity R0_{z} can be considered to be a coefficient showing the degree of contribution that the change of the angular velocity R0_{z} gives the X component C1ₓ.

Clearly by referring to FIG. 1A or 1B, the movement speed of the link 26 when the joint 41 is rotated depends on the lengths (link lengths) from the joint 41 to the respective links 21 to 25 that are present up to the link 26, and the angles θ1 to θ6 in the respective joints 41 to 46. Moreover, although the link lengths of the respective links 21 to 25 do not change, the angles θ1 to θ6 in the respective joints 41 to 46 change. Accordingly, the X component C1ₓ of the movement speed of the link 26 becomes a function that has the angles θ1 to θ6 in the respective joints 41 to 46 as variables. From this, the coefficient (dC1ₓ/dθ1) showing the degree of contribution of the angular velocity R0_{z} is given by a partial differential coefficient obtained by partially differentiating the X component C1ₓ of the movement speed by the variable θ1.

Similarly, a coefficient (dC1ₓ/dθ2) showing the degree of contribution of angular velocity ω2, a coefficient (dC1ₓ/dθ3) showing the degree of contribution of the angular velocity ω3, a coefficient (dC1ₓ/dθ4) showing the degree of contribution of the angular velocity ω4, a coefficient (dC1ₓ/dω5) showing the degree of contribution of the angular velocity ω5, and a coefficient (dC1ₓ/dθ6) showing the degree of contribution of the angular velocity ω6 are given by partial differential coefficients obtained by partially differentiating the X component C1ₓ of the movement speed by the respective variables θ2 to θ6.

Although the X component C1ₓ of the movement speed of the link 26 has been described above, the same totally applies to the Y component C1_{y} and the Z component C1_{z} of the movement speed. That is, the Y component C1_{y} of the movement speed and the Z component C1_{z} of the movement speed are expressed by the linear combination of the angular velocity R0_{z} of the joint 41 and the angular velocities ω2 to ω6 of the joints 42 to 46, and the coefficients showing the respective degrees of contribution become partial differential coefficients obtained by partially differentiating the Y component C1_{y} of the movement speed or the Z component C1_{z} of the movement speed by the variables θ1 to θ6, respectively. Then, if these coefficients are put together in the form of a matrix, an expression illustrated in FIG. 4B can be obtained.

In addition, the expression illustrated in FIG. 4B in relation to the first arm Jacobian J1 will be supplementarily described. The reason why the first arm Jacobian J1 becomes the matrix illustrated in FIG. 4B is because the rotational axis (here, R0_{z} axis) that the gyro sensor 30 detects and the rotational axis of the joint 41 coincide with each other. However, the rotational axis that the gyro sensor 30 detects and the rotational axis of the joint 41 do not necessarily coincide with each other. In such a case, if the posture angles of the gyro sensor 30 are defined as θ_{R0x}, θ_{R0y}, and θ_{R0z}, the expression illustrated in FIG. 4D is established. Here, a value obtained by time-differentiating the posture angle θ_{R0x} is an angular velocity R0ₓ, a value obtained by time-differentiating the posture angle θ_{R0y} is an angular velocity R0_{y}, and a value obtained by time-differentiating the posture angle θ_{R0z} is an angular velocity R0_{z}. Here, since the R0z axis of the gyro sensor 30 and the axis of θ1 coincide with each other, all partial differential coefficients in θ_{R0y} and θ_{R0z} become 0 in FIG. 4D, and θ_{R0x} can be substituted with θ1. The expression obtained in this way becomes the expression illustrated in FIG. 4B.

Clearly from the above, the first arm Jacobian J1 is the matrix that depends on the link lengths and shapes of the respective links 21 to 26 that form the first arm 20 and has the angles θ1 to θ6 of the joints 41 to 46 as the variables. Since the link lengths of the respective links 21 to 26 are known in advance, if the angles θ1 to θ6 are detected from the outputs of the angle sensors 41s to 46s, the first arm Jacobian J1 at that time can be determined. The first movement speed computing unit 52 computes the respective components C1ₓ, C1_{y}, and C1_{z} of the movement speed of the link 26, using the first arm Jacobian J1 from the output of the gyro sensor 30 and the outputs of the angle sensors 41s to 46s, as described above. In addition, in the first embodiment, the angle sensors 42s to 46s that detect the angles of the respective joints 42 to 46 of the first arm 20 correspond to a “first angle detection unit” in the invention. Additionally, the movement speed of the link 26 obtained by the computation using the first arm Jacobian J1 is equivalent to a “first movement speed” in the invention.

### A-2-2. First Strain Rate Computing Unit

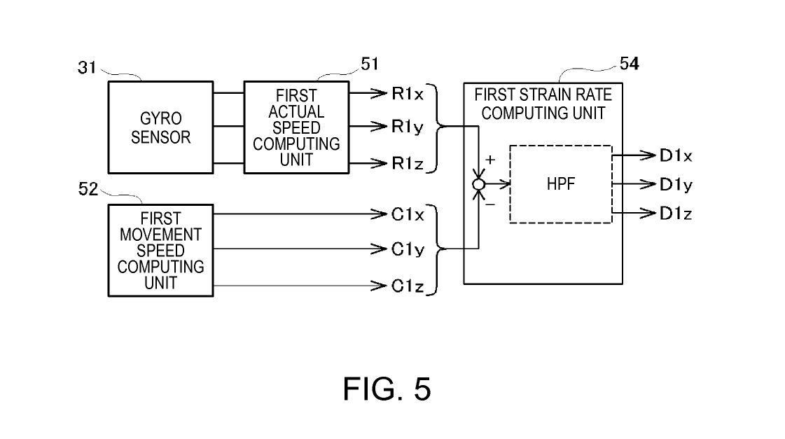

FIG. 5 is an explanatory view of the contents of computation that the first strain rate computing unit 54 of the controller 50 executes. The first strain rate computing unit 54 computes the deviations between the computation values C1ₓ, C1_{y}, and C1_{z} obtained by the aforementioned first movement speed computing unit 52 regarding the respective components of the movement speed of the link 26, and an actual movement speed detected by the gyro sensor 31.

After the outputs of three axes of the gyro sensor 31 is AD-converted by the first actual speed computing unit 51, the converted outputs are multiplied by predetermined conversion coefficients and thereby converted into respective components R1x, R1y, and R1z of the actual movement speed of the link 26. Additionally, the respective XYZ components of the movement speed computed by the first movement speed computing unit 52 as mentioned above are set so as to have the same direction components as the three XYZ axis components detected by the gyro sensor 31. For this reason, the first strain rate computing unit 54 can subtract the output of the first movement speed computing unit 52 from the output of the first actual speed computing unit 51 for each component. Then, the respective components D1ₓ, D1_{y}, and D1_{z} of the first strain rate of the link 26 can be obtained by passing the obtained deviations through a high-pass filter (HPF). In addition, the actual movement speed detected by the gyro sensor 31 is equivalent to a “first actual speed” in the invention.

The first strain rates (D1ₓ, D1_{y}, and D1_{z}) obtained in this way results from deformation in the respective links 21 to 26 and the joints 41 to 46 that are not taken into consideration when the first movement speed computing unit 52 computes the movement speeds (C1ₓ, C1_{y}, and C1_{z}) of the link 26. A phenomenon in which the hand portion vibrates when the hand portion or the like attached to the tip of the first arm 20 is moved to and stopped at a target position also occurs due to the deformation in the respective links 21 to 26 and joints 41 to 46. Accordingly, if the influence of the deformation in the links 21 to 26 and the joints 41 to 46 is suppressed by feeding back the first strain rates obtained by the first strain rate computing unit 54 to the first motors (motors 42m to 46m) mounted on the respective joints 41 to 46 of the first arm 20 and the base-side motor 41m, it is possible to suppress the vibration when the first arm 20 is stopped. The first strain rate computing unit 54 computes the first strain rate for each component on the basis of such an idea.

### A-2-3. First Correction Rate Computing Unit

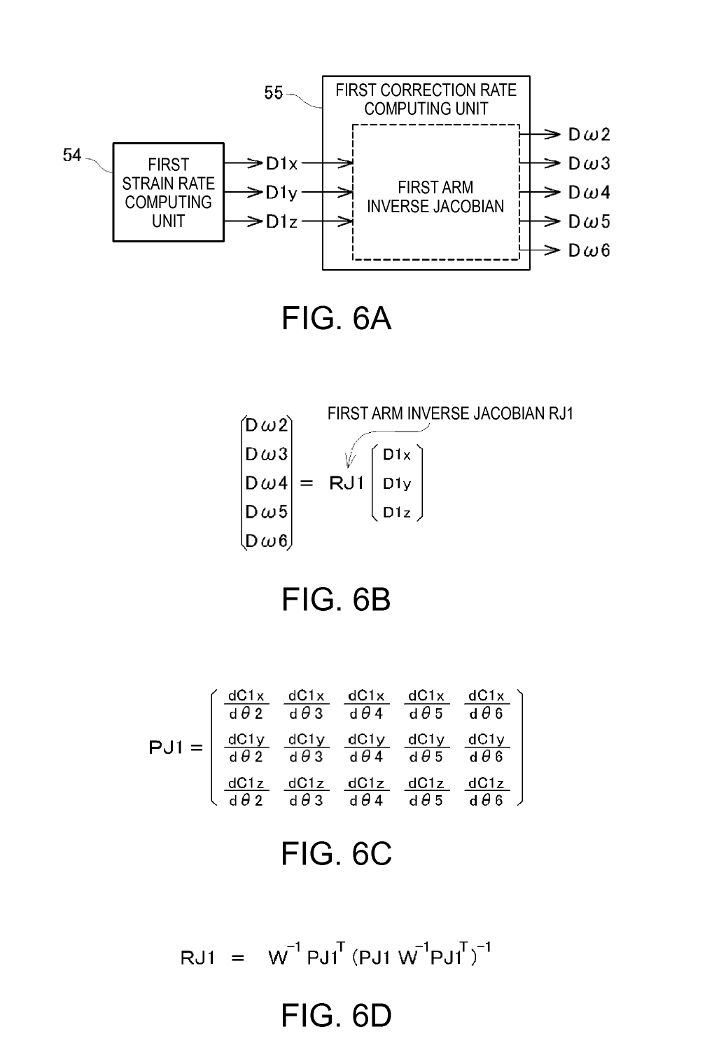

FIGS. 6A to 6D are explanatory views of the contents of computation that the first correction rate computing unit 55 of the controller 50 executes. As illustrated in FIG. 6A, the first correction rate computing unit 55 performs the computation of converting the first strain rates (D1ₓ, D1_{y}, and D1_{z}) obtained by the above-described first strain rate computing unit 54 into correction rates Dω2 to Dω6 (hereinafter may be referred to as first correction rates) regarding the respective joints 42 to 46 of the first arm 20. That is, the first strain rates generated due to the deformation in the links 21 to 26 and the joints 42 to 46 of the first arm 20 are obtained for respective components having the XYZ axes of the gyro sensor 31 as references. Accordingly, it is necessary to determine how the joints 42 to 46 share and realize the suppression of the first strain rate.

Thus, the first correction rate computing unit 55 computes the correction rates Dω2 to Dω6 regarding the angular velocities ω2 to ω6 of the joints 42 to 46 from the respective components D1ₓ, D1_{y}, and D1_{z} of the first strain rate obtained by the above-described first strain rate computing unit 54. In addition, since the base-side strain rate computing unit 58 to be described below computes the correction rate of the angular velocity ω1 of the joint 41, the first correction rate computing unit 55 may compute the correction rates Dω2 to Dω6 regarding the joints 42 to 46.

Here, the first arm Jacobian J1 mentioned above with reference to FIGS. 4A to 4D is a matrix that converts the angular velocity R0_{z} and ω2 to ω6 of the joints 41 to 46 into the movement speeds C1ₓ, C1_{y}, and C1_{z} of the link 26. In contrast, a matrix for determining correction amounts regarding the angular velocities ω2 to ω6 of the joints 42 to 46 (that is, the correction rates Dω2 to Dω6) from the correction amounts (that is, the first strain rates D1ₓ, D1_{y}, and D1_{z}) of the movement speed of the link 26 becomes a matrix that performs inverse conversion to the first arm Jacobian J1. Accordingly, the matrix that performs inverse conversion to the first arm Jacobian J1 is referred to as a first arm inverse Jacobian RJ1. If the first arm inverse Jacobian RJ1 is used, the first correction rates Dω2 to Dω6 can be determined by performing matrix computation illustrated in FIG. 6B from the first strain rates D1ₓ, D1_{y}, and D1_{z}.

However, the computation of determining the first correction rates Dω2 to Dω6 regarding the joints 42 to 46 from the first strain rates D1ₓ, D1_{y}, and D1_{z} becomes an inverse problem in which five variable values (Dω2 to Dω6) are determined from three input values (D1ₓ, D1_{y}, and D1_{z}). For this reason, the first correction rates Dω2 to Dω6 cannot be uniquely determined from the first strain rates D1ₓ, D1_{y}, and D1_{z}. However, if the easiness of the deformation of the links 21 to 26 and the joints 42 to 46 is used as a constraint condition, it is possible to determine the five variable values (Dω2 to Dω6) from the three input values (D1ₓ, D1_{y}, and D1_{z}).

Thus, as illustrated in FIG. 6C, a partial matrix PJ1 excluding a component related to the angular velocity R0_{z} from the first arm Jacobian J1 and a five by five weight matrix W in which the angles θ2 to θ6 are weighted are supposed, and the first arm inverse Jacobian RJ1 is determined by matrix computation illustrated in FIG. 6D. In addition, the weighing matrix W is a matrix showing the easiness of the deformation in the links 21 to 26 and the joints 42 to 46. Additionally, the sign “−1” in FIG. 6D represents an inverse matrix, and the sign “T” in FIG. 6D represents a transposed matrix.

The first correction rate computing unit 55 of the first embodiment computes the correction amounts (first correction rates Dω2 to Dω6) regarding the angular velocities ω2 to ω6 of the joints 42 to 46 as mentioned above if the first correction rate computing unit 55 receives the first strain rates D1ₓ, D1_{y}, and D1_{z} from the first strain rate computing unit 54. Then, the obtained first correction rates Dω2 to Dω6 are output to the first motor drive unit 56.

### A-2-4. First Motor Drive Unit

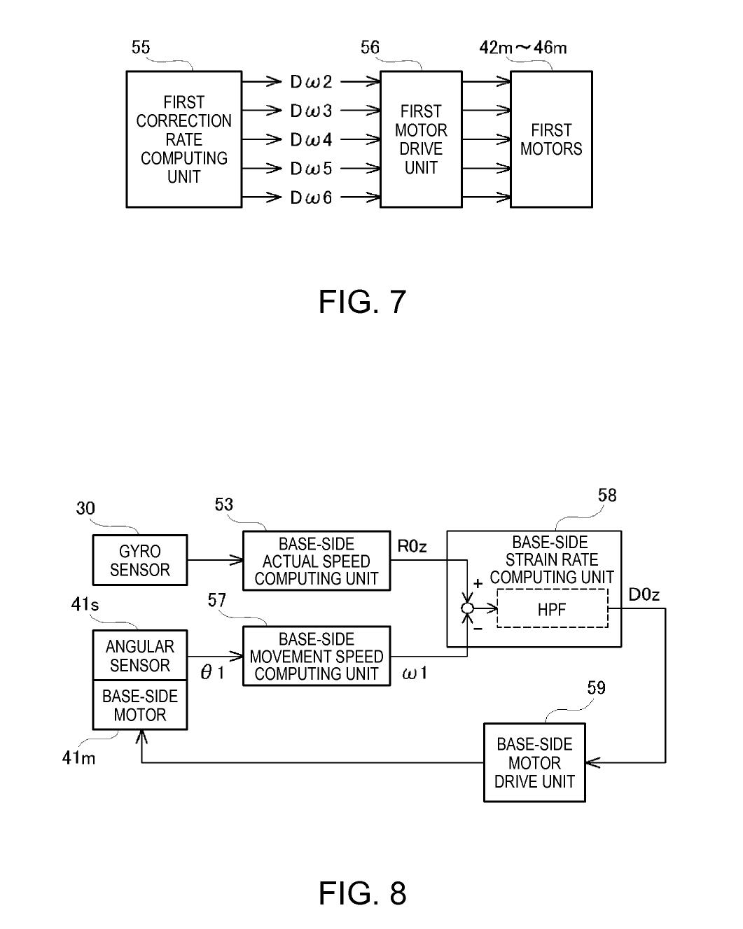

FIG. 7 is an explanatory view of the contents of computation that the first motor drive unit 56 of the controller 50 executes. The first motor drive unit 56 controls the first motors (motors 42m to 46m) mounted on the joints 42 to 46, respectively, for each motor if the first correction rates Dω2 to Dω6 regarding the joints 42 to 46 are received from the first correction rate computing unit 55.

### A-2-5. Control Contents Regarding Base-Side Motor

FIG. 8 is an explanatory view illustrating the operation that the base-side actual speed computing unit 53, the base-side movement speed computing unit 57, the base-side strain rate computing unit 58, and the base-side motor drive unit 59 of the controller 50 controls the base-side motor 41m.

The base-side actual speed computing unit 53 computes the actual speed R0_{z} of the link 21 with respect to the base 10 by multiplying a predetermined conversion coefficient after AD conversion is performed if the base-side actual speed computing unit 53 receives the output from the gyro sensor 30 attached to the link 21. Additionally, the base-side movement speed computing unit 57 computes the angular velocity ω1 of the joint 41 by calculating a differential value (or variation per time) of the angle θ1 if the base-side movement speed computing unit 57 receives the angle θ1 of the link 21 with respect to the base 10 from the angle sensor 41s. In addition, in the first embodiment, the angle sensor 41s that detects the angle of the joint 41 corresponds to a “base-side angle detection unit” in the invention. Additionally the angular velocity ω1 corresponds to a “base-side movement speed” in the invention.

Then, the base-side strain rate computing unit 58 computes a base-side strain rate D0_{z} by subtracting the angular velocity ω1 obtained by the base-side movement speed computing unit 57 from the actual speed R0_{z} obtained by the base-side actual speed computing unit 53, and by passing the obtained subtraction result through a high-pass filter (HPF). In addition, in the first movement speed computing unit 52 mentioned above with reference to FIGS. 4A to 4D, the strain rates are computed after the angular velocities ω2 to ω6 of the joints 42 to 46 are converted into the angular velocities C1ₓ, C1_{y}, and C1_{z} of the same coordinate axes as the gyro sensor 31, using the first arm Jacobian J1. In contrast, as mentioned above with reference to FIGS. 1A and 1B, since the gyro sensor 30 is attached so that the Z-axis of the gyro sensor 30 has the same direction as the rotational axis of the joint 41, the conversion of the coordinate axes is unnecessary. For this reason, the base-side strain rate D0_{z} can be immediately computed simply by subtracting the angular velocity ω1 of the joint 41 from the actual speed R0ₓ obtained from the gyro sensor 30.

The base-side motor drive unit 59 controls the operation of the base-side motor 41m on the basis of the base-side strain rate D0_{z} obtained in this way. In addition, as mentioned above with reference to FIG. 7, the first motor drive unit 56 controls the first motors (motors 42m to 46m) after the first strain rates D1ₓ, D1_{y}, and D1_{z} obtained by the first strain rate computing unit 54 are converted into a coordinate system using the angular velocities ω2 to ω6 of the joints 42 to 46 by the first correction rate computing unit 55. In contrast, since the Z-axis of the gyro sensor 30 has the same direction as the rotational axis of the joint 41, the base-side motor 41m can be immediately controlled on the basis of the base-side strain rate D0_{z} without converting the coordinate axes.

In the robot 1 of the first embodiment described above, the strain rates (the first strain rates D1ₓ, D1_{y}, and D1_{z} and the base-side strain rate D0_{z}) that are generated due to the deformation of the links 21 to 26 of the first arm 20 and the joints 41 to 46, and on the basis of the results thereof, the operation of the first motors (motors 42m to 46m) of the joints 42 to 46 and the motor 41m of the joint 41 is feedback-controlled. Generally, the vibration generated when the tip of the first arm 20 is moved and stopped results from the deformation of the links 21 to 26 of the first arm 20 and the joints 41 to 46. However, in the robot 1 of the first embodiment, the strain rates are detected to feedback-control the motors 41m to 46m. Thus, the influence exerted by the deformation of the links 21 to 26 of the first arm 20 and the joints 41 to 46 can be suppressed. As a result, since it is also possible to suppress the vibration of the first arm 20 generated due to the deformation of the links 21 to 26 of the first arm 20 and the joints 41 to 46, it is possible to rapidly stop the vibration of the first arm 20 in order to start work using the hand portion or the like.

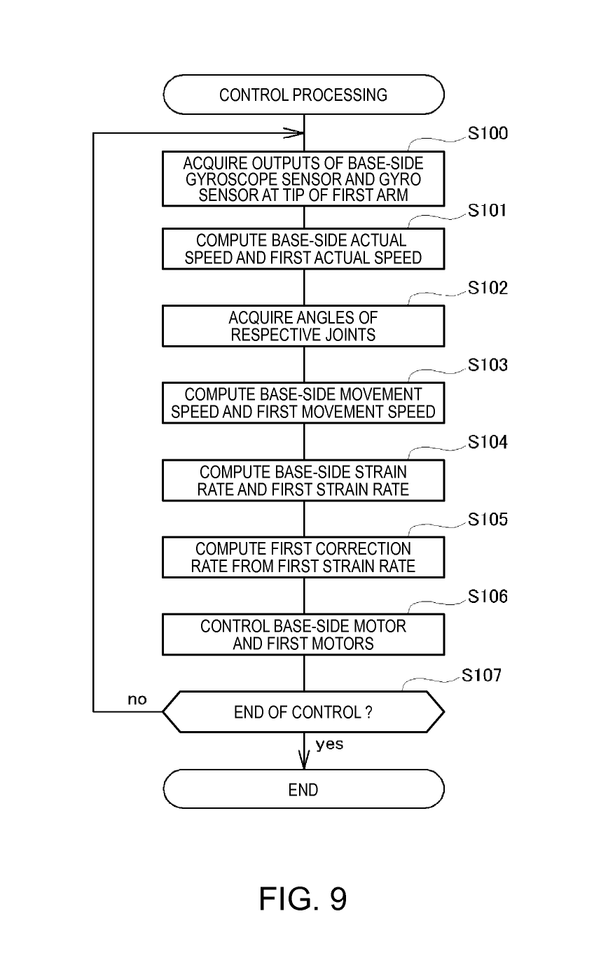

In addition, the above-described first embodiment has been described so that the nine “units” in the controller 50 illustrated in FIG. 3 are realized by a hardware using LSI or the like, a software using a computer program, or the combination thereof. Of course, a computer program that performs all the above-described computations can be stored in the memory 50m. FIG. 9 is a flowchart of the control processing that the controller 50 executes using such a computer program.

If the control processing illustrated in FIG. 9 is started, the controller 50 acquires the output of the gyro sensor 30 attached to the link 21 on the base 10 side and the output of the gyro sensor 31 attached to the link 26 at the tip of the first arm 20 (Step S100). Then, on the basis of these outputs, the actual speed (base-side actual speed R0_{z}) of the link 21 on the base 10 side and the actual speeds (first actual speeds R1ₓ, R1_{y}, and R1_{z}) of the link 26 are computed (Step S101).

Subsequently, the angles θ1 to θ6 of the joints 41 to 46 are acquired from the angle sensors 41s to 46s built in the motors 41m to 46m of the joints 41 to 46 (Step S102). Then, the base-side movement speed ω1 is computed by obtaining the differential value (or variation per time) of the angle θ1. Similarly, the first movement speeds C1ₓ, C1_{y}, and C1_{z} are computed by applying the aforementioned first arm Jacobian J1 to the angular velocities ω2 to ω6 obtained by calculating the differential values (or variation per time) of angles θ2 to θ6 (Step S103).

Then, the base-side strain rate D0_{z} is computed by taking the deviation between the base-side actual speed R0_{z} obtained in Step S101 and the base-side movement speed ω1 obtained in Step S103 and by passing the deviation through a high-pass filter. Similarly, the first strain rates D1ₓ, D1_{y}, and D1_{z} are computed by taking the deviations between the first actual speeds R1ₓ, R1_{y}, and R1_{z} obtained in Step S101 and the first movement speeds C1ₓ, C1_{y} and C1_{z} obtained in Step 103 and passing the deviations through the high-pass filter (Step S104).

Then, the correction amounts (first correction rates Dω2 to Dω6) of the angular velocities of the first motors (motors 42m to 46m) are computed by applying the aforementioned first arm inverse Jacobian RJ1 to the first strain rates D1ₓ, D1_{y}, and D1_{z} (Step S105).

Then, the operation of the base-side motor 41m is controlled in accordance with the base-side strain rate D0_{z}, and similarly, the operation of the first motors (motors 42m to 46m) is controlled in accordance with the first correction rates Dω2 to Dω6 (Step S106). Thereafter, it is determined whether or not the control is ended (Step S107), and when the control is continued (Step S107: no), the processing returns to the head of the processing where a series of the above-described processing (Steps S100 to S107) is repeated. In contrast, when the control is ended (Step S107: yes), the control processing of FIG. 9 is ended.

Even by executing the program described above, the influence exerted by the deformation of the links 21 to 26 of the first arm 20 and the joints 41 to 46 can be suppressed by detecting the strain rates (the first strain rates D1ₓ, D1_{y}, and D1_{z} and the base-side strain rate D0_{z}) generated due to the deformation of the links 21 to 26 of the first arm 20 and the joints 41 to 46 to feedback-control the operation of the motors 41m to 46m. For this reason, it is also possible to suppress the vibration of the first arm 20 generated due to the deformation of the links 21 to 26 of the first arm 20 and the joints 41 to 46.

### B. Second Embodiment

The above-described first embodiment has been described so that the base 10 to which the first arm 20 is attached does not have joints other than the joint 41 between the base and the first arm 20 and the base 10 is fixed to the ground. However, the base 10 may be fixed to the ground via joints other than the joint 41. Such a second embodiment will be described below.

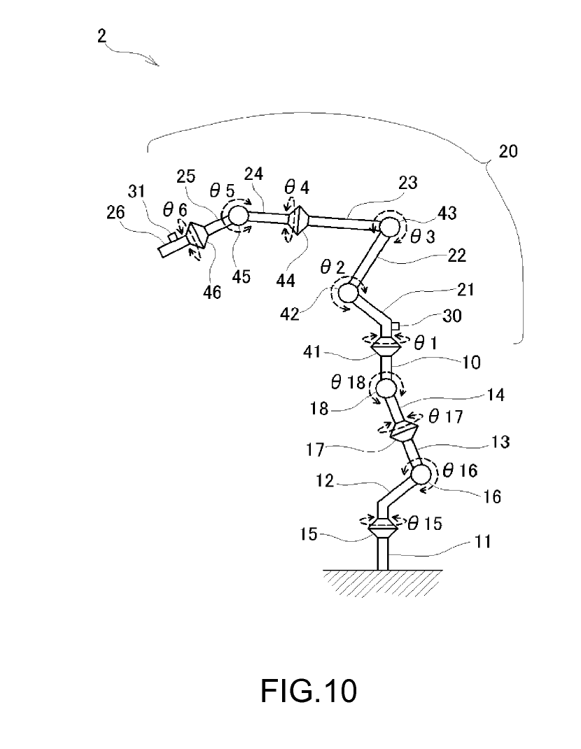

FIG. 10 is an explanatory view illustrating a rough configuration of a robot 2 of the second embodiment. Even the robot 2 of the second embodiment, the first arm 20 is the same as that of the aforementioned first embodiment. That is, the first arm 20 includes the six links 21 to 26 and the five joints 42 to 46 that link the links 21 to 26. Additionally, the motors 42m to 46m and the angle sensors 42s to 46s are built in the respective joints 42 to 46. Moreover, the gyro sensor 30 and the gyro sensor 31 are attached to the link 21 and the link 26, respectively.

Additionally, even in the robot 2 of the second embodiment, the first arm 20 is linked to the base 10 via the joint 41, and the motor 41m and the angle sensor 41s are built in the joint 41. However, in the robot 2 of the second embodiment, the base 10 is a kind of link (hereinafter, a link 10), the base 10 (link 10) is linked to a link 14 via a joint 18, the link 14 is linked to a link 13 via a joint 17, the link 13 is linked to a link 12 via a joint 16, the link 12 is linked to a link 11 via a joint 15, and the link 11 is fixed to the ground. In other words, the robot 2 of the second embodiment has the structure in which the first arm 20 is attached to a tip of an arm including the five links 10 to 14 and the four joints 15 to 18 via the joint 41. Additionally, motors 15m to 18m to be described below and angle sensors 15s to 18s for driving the joints are built in the respective joints 15 to 18, similar to the other joints 41 to 46. In addition, in the second embodiment, the motors 15m to 18m and the motor 41m may be referred to as “base-side motors”. Additionally, in the second embodiment, the angle sensors 15s to 18s correspond to a “base-side angle detection unit” in the invention.

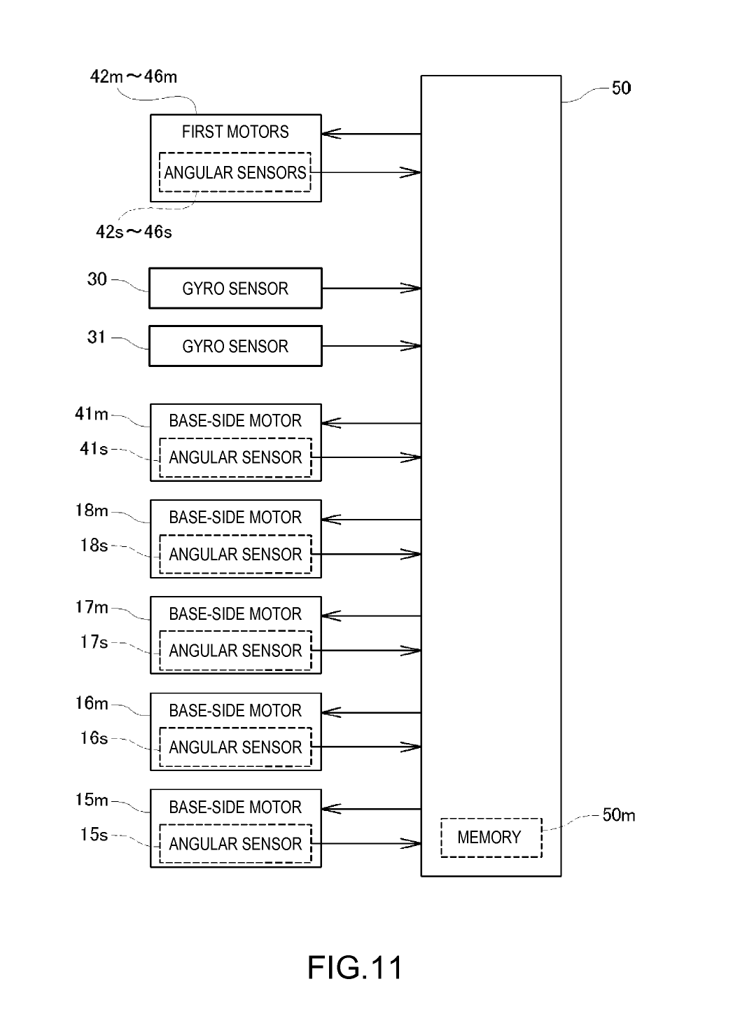

FIG. 11 is an explanatory view of a connection relationship between the motors 15m to 18m and 41m to 46m and the angle sensors 15s to 18s and 41s to 46s provided at the respective joints 15 to 18 and 41 to 46 of the robot 2 of the second embodiment, and the controller 50. In addition, since the first motors (motors 42m to 46m) and the angle sensors 42s to 46s built in these first motors are the same as those of the robot 1 of the aforementioned first embodiment, these are put together into one and expressed. Even in the second embodiment, the output of the angle sensors 42s to 46s and the outputs of the gyro sensors 30 and 31 are input to the controller 50. The controller 50 controls the operation of the first motors (motors 42m to 46m) on the basis of these outputs.

Additionally, the angle sensor 15s that detects an angle θ15 of the joint 15 is built in the motor 15m for driving the joint 15, and the output of the angle sensor 15s is input to the controller 50. Similarly, the angle sensor 16s that detects an angle θ16 of the joint 16 is built in the motor 16m for driving the joint 16, the angle sensor 17s that detects an angle θ17 of the joint 17 is built in the motor 17m for driving the joint 17, and the angle sensor 18s that detects an angle θ18 of the joint 18 is built in the motor 18m for driving the joint 18. Then, the outputs of the angle sensors 16s to 18s are also input to the controller 50. Then, the controller 50 of the second embodiment controls the operation of the base-side motors 15m to 18m and 41m.

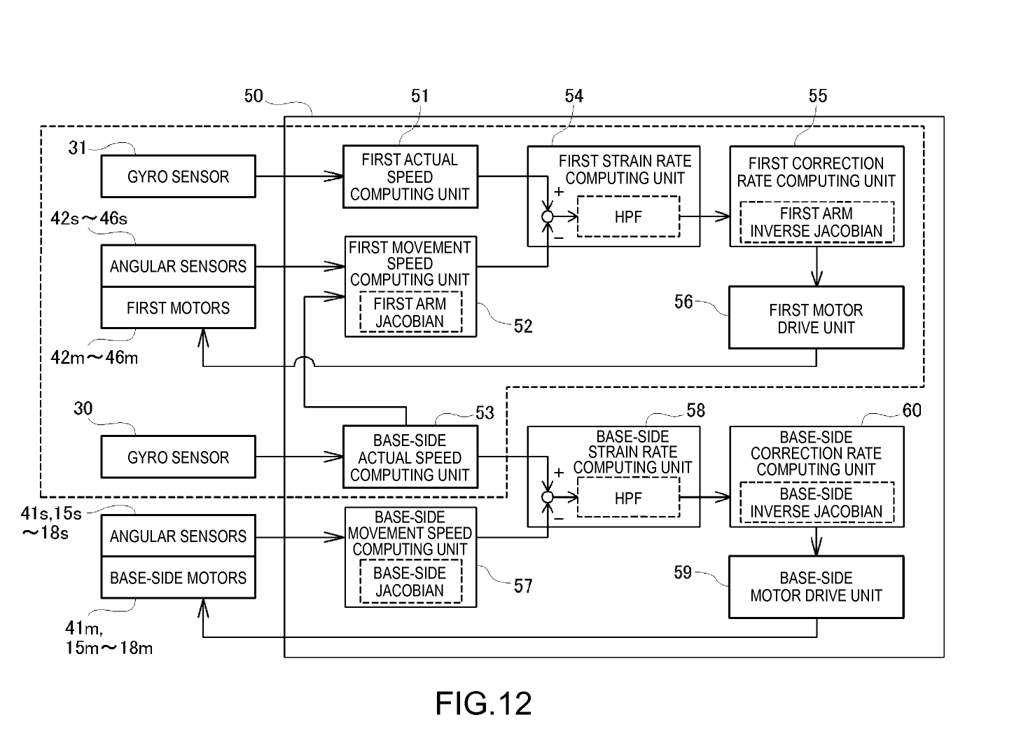

FIG. 12 is a block diagram conceptually illustrating an internal configuration of the controller 50 of the second embodiment. Similar to the controller 50 of the aforementioned first embodiment with reference to FIG. 3, the controller 50 of the second embodiment includes the first actual speed computing unit 51, the first movement speed computing unit 52, the first strain rate computing unit 54, the first correction rate computing unit 55, the first motor drive unit 56, the base-side actual speed computing unit 53, the base-side movement speed computing unit 57, the base-side strain rate computing unit 58, and the base-side motor drive unit 59. Among these, the first actual speed computing unit 51, the first movement speed computing unit 52, the first strain rate computing unit 54, the first correction rate computing unit 55, and the first motor drive unit 56 are the same as those of the aforementioned first embodiment except that the item of the angular velocity R0ₓ of the gyro sensor 30 around the X-axis and the item of the angular velocity R0_{y} thereof around the Y-axis increase in the first movement speed computing unit 52. This is because the robot 2 of the second embodiment also includes the first arm 20 having completely the same configuration as that of the robot 1 of the first embodiment.

Meanwhile, in the robot 2 of the second embodiment, the base 10 to which the first arm 20 is attached also includes the five links 10 to 14 and the four joints 15 to 18 and has the same structure as the first arm 20. For this reason, the base-side motors 15m to 18m, and 41m are controlled in the same way as the first motors (motors 42m to 46m). That is, the base-side actual speed computing unit 53 that computes the base-side actual speed from the gyro sensor 30 is provided corresponding to the first actual speed computing unit 51 that computes the first actual speed from the gyro sensor 31, and the base-side movement speed computing unit 57 that computes the base-side movement speeds (movement speeds at a position where the gyro sensor 31 is mounted), using the angles θ15 to θ18 and θ1 detected by the angle sensors 15s to 18s and 41s is provided corresponding to the first movement speed computing unit 52 that computes the first movement speed using the angles θ2 to θ6 detected by the angle sensors 42s to 46s. The base-side movement speed computing unit 57 computes the base-side movement speed, using a base-side Jacobian to be described below. Additionally, the base-side strain rate computing unit 58 is provided corresponding to the first strain rate computing unit 54, a base-side correction rate computing unit 60 is provided corresponding to the first correction rate computing unit 55, and the base-side motor drive unit 59 is provided corresponding to the first motor drive unit 56. The base-side correction rate computing unit 60 computes a base-side correction rate, using a base-side inverse Jacobian to be described below.

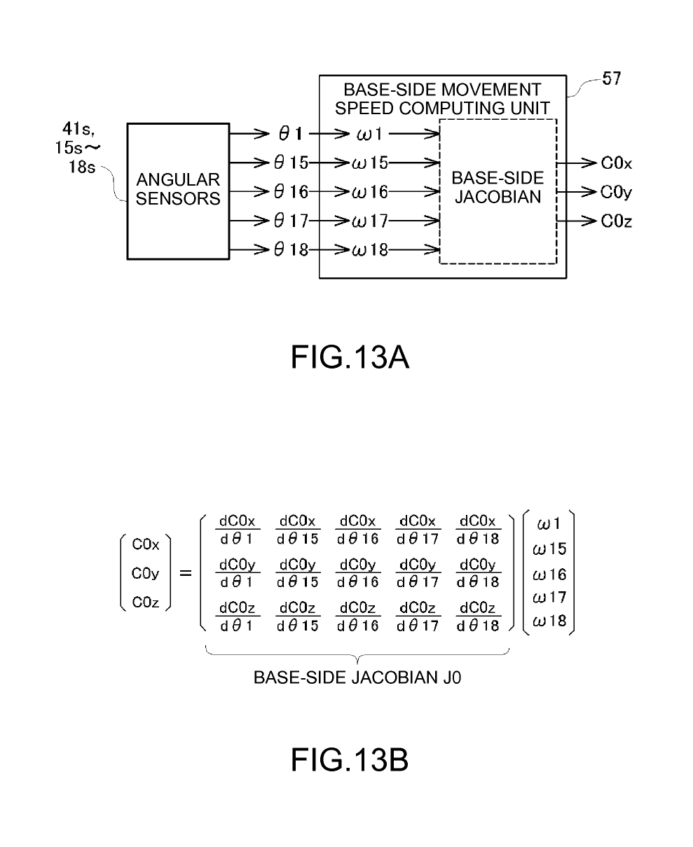

FIGS. 13A and 13B are explanatory views illustrating a method through which the base-side movement speed computing unit 57 of the second embodiment computes movement speeds (base-side movement speeds C0ₓ, C0_{y}, and C0_{z}) in a place where the gyro sensor 30 is mounted. Similar to the first movement speed computing unit 52 mentioned above with reference to FIGS. 4A to 4D, the base-side movement speed computing unit 57 can also compute the base-side movement speeds C0ₓ, C0_{y}, and C0_{z}, using a base-side Jacobian J0 from the angles θ15 to θ18 and θ1 obtained by the angle sensors 15s to 18s and 41s. In addition, the aforementioned first arm Jacobian J1 is given in a matrix that depends on the link lengths and shapes of the links 21 to 26 of the first arm 20 and has the angles θ1 to θ6 of the joints 41 to 46 as variables. Exactly in the same way as this, the base-side Jacobian J0 is given as a matrix illustrated in FIG. 13B that depends on the link lengths and shapes of the base-side links 10 to 14 and has the angles θ15 to θ18 and θ1 of the joints 15 to 18 and 41 as variables.

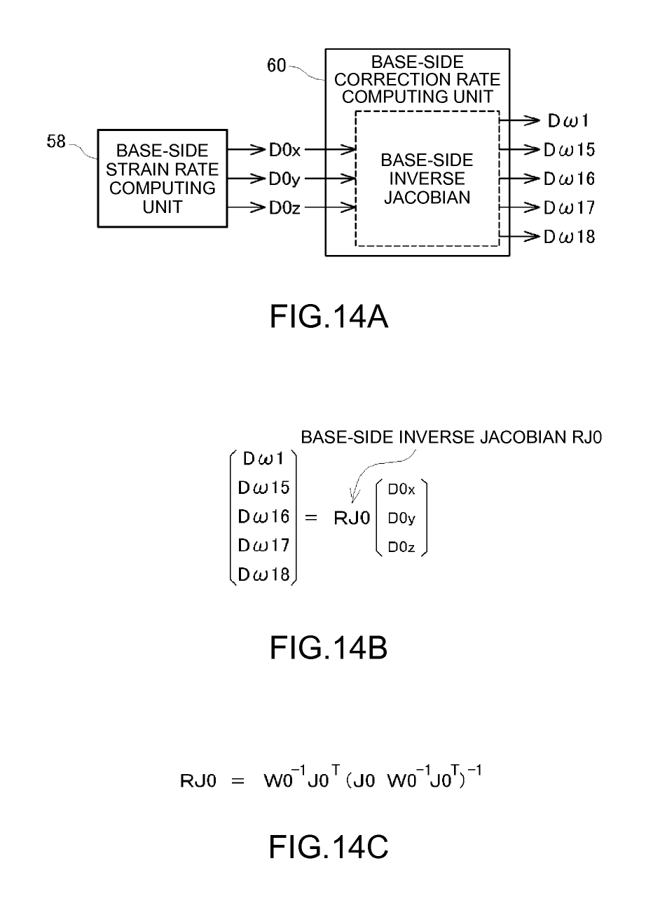

FIGS. 14A to 14C are explanatory views illustrating a method through which the base-side correction rate computing unit 60 of the second embodiment computes correction rates (base-side correction rates Dω1 and Dω15 to Dω18) regarding the base-side motors 15m to 18m and 41m. The first correction rate computing unit 55 mentioned above with reference to FIGS. 6A to 6D converts the first strain rates D1ₓ, D1_{y}, and D1_{z} obtained by the first strain rate computing unit 54 into the correction rates Dω2 to Dω6 of the respective joints 42 to 46 of the first arm 20, using the first arm inverse Jacobian RJ1. Exactly in the same way as this, the base-side correction rate computing unit 60 converts base-side strain rates D0ₓ, D0_{y}, and D0_{z} obtained by the base-side strain rate computing unit 58 into the correction rates (base-side correction rates Dω1, Dω15, Dω16, Dω17, and Dω18) of the base-side joints 41 and 15 to 18.

The conversion from the base-side strain rates D0ₓ, D0_{y}, and D0_{z} into the base-side correction rates Dω1, Dω15, Dω16, Dω17, and Dω18 at this time is performed using a base-side inverse Jacobian RJ0 as illustrated in FIG. 14B. Additionally, the base-side inverse Jacobian RJ0 can be obtained by matrix computation of FIG. 14C, using a weighing matrix W0 in which the angles θ1 and θ15 to 18 of the base-side joints 41, 15 to 18 are weighted, exactly in the same way as the first arm inverse Jacobian RJ1.

The base-side motor 41m and the motors 15m to 18m are controlled by supplying the base-side correction rates Dω1 and Dω15 to 18 obtained in this way to the base-side motor drive unit 59. If this is the case, the vibration of the base 10 (link 10) can be suppressed even when the base 10 to which the first arm 20 is connected is fixed to the ground via the other links 11 to 14. As a result, since the vibration of the tip of the first arm 20 can also be suppressed, it is possible to rapidly start work after the hand portion or the like attached to the tip of the first arm 20 is moved to a target position.

In addition, the above-described second embodiment has been described so that the first arm 20 is attached to the tip of the base-side arm formed by the links 10 to 14 and the joints 41 and 15 to 18. However, another arm may be attached to the tip of the first arm 20.

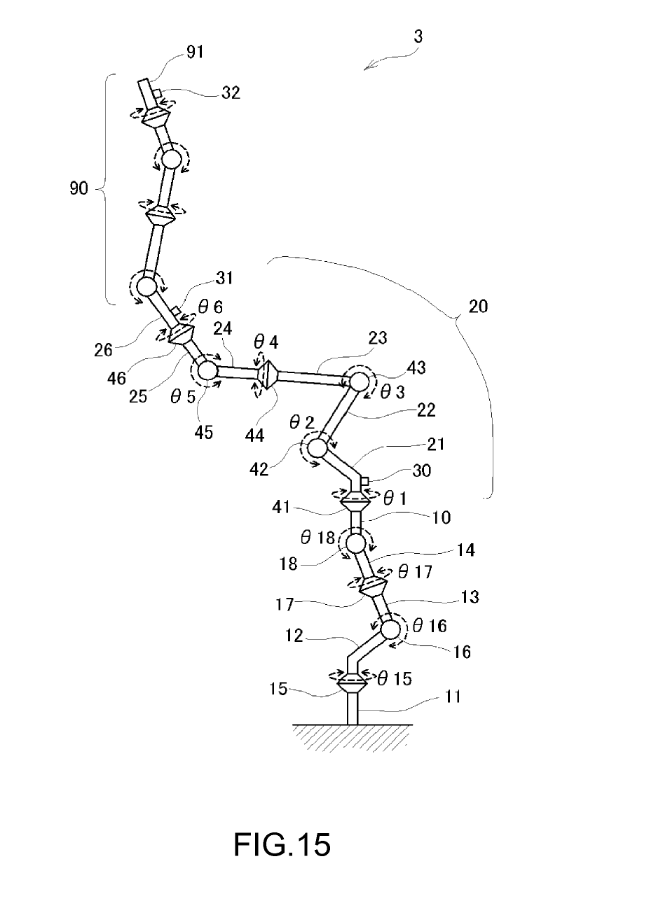

FIG. 15 is an explanatory view illustrating a general structure of a robot 3 that is another aspect of the second embodiment in which a tip-side arm 90 is linked to the tip of the first arm 20. As illustrated in the drawing, in the robot 3 of the other aspect, the tip-side arm 90 is linked to the tip of the first arm 20, with respect to the robot 2 of the second embodiment. Even in the robot 3 of such another aspect, if the gyro sensor 32 is attached to a link 91 at a tip of the tip-side arm 90, the vibration of the link 91 can be suppressed, exactly in the same way as the first arm 20 of the second embodiment. As a result, it is possible to rapidly start work after the hand portion or the like attached to the tip of the tip-side arm 90 is moved to a target position.

Additionally, in the aforementioned robots 2 and 3 of the second embodiment, a configuration in which a plurality of gyro sensors are attached to one arm to which a number of links and joints are connected is conceivable. Then, the control of the respective joints is performed in units of a plurality of small arms depending on the positions of the gyro sensors, as mentioned above with reference to FIG. 12. Although matrix computation using a Jacobian and an inverse Jacobian is performed in such control in units of small arms, quick computation becomes difficult because the scale of a matrix becomes larger as the number of joints constituting the arm increases. From such a viewpoint, in the robots 2 and 3 of the second embodiment, quick control is realized by attaching the gyro sensors in the middle of the arm that has multiple joints, thereby dividing the arm into the plurality of small arms to control the operation of each joint for each small arm.

### C. Third Embodiment

The above-described second embodiment has been described so that the plurality of arms are linked in series. However, a plurality of arms may be linked in parallel.

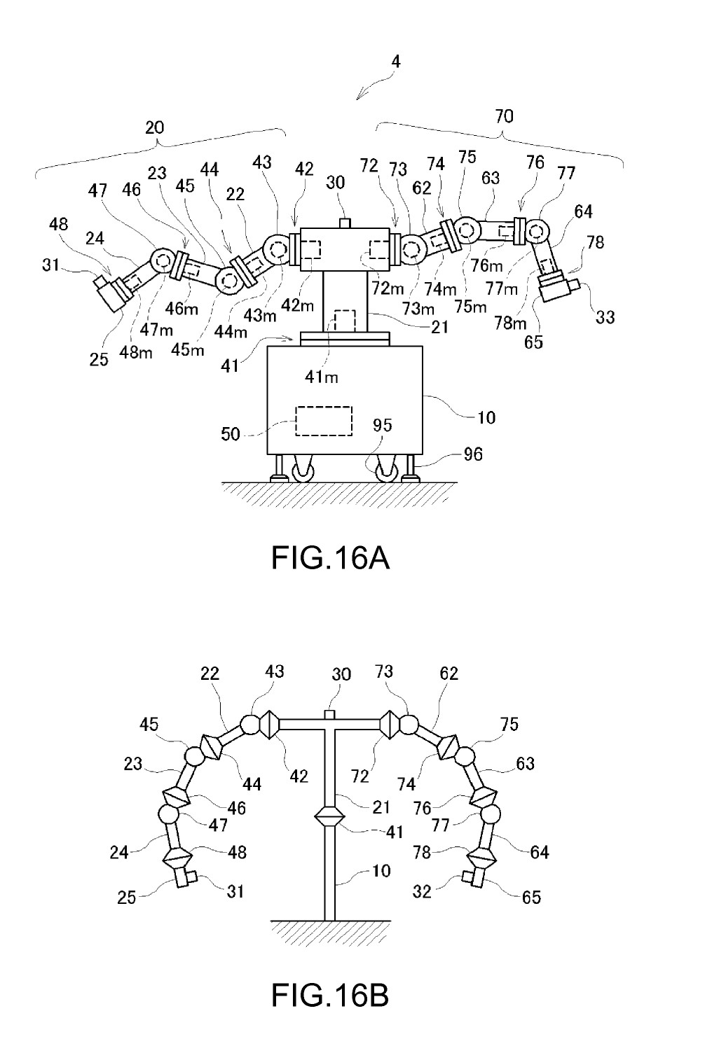

FIGS. 16A and 16B are explanatory views illustrating a rough configuration of a robot 4 of a third embodiment. The first arm 20 that the robot 4 of the third embodiment has as illustrated includes the link 21 connected to the base 10 via the joint 41, the link 22 connected to the link 21 via the joint 42 and the joint 43, the link 23 connected to the link 22 via the joint 44 and the joint 45, the link 24 connected to the link 23 via the joint 46 and a joint 47, and the link 25 connected to the link 24 via a joint 48. Motors 41m to 48m for driving the respective joints 41 to 48 are built in the joints 41 to 48, and angle sensors 41s to 48s (to be described below) that detect the angles of the joints are assembled into the respective motors 41m to 48m.

Additionally, a second arm 70 is also mounted on the robot 4 of the third embodiment, in a state in which the first arm 20 and the first link 21 are shared. The configuration of the second arm 70 is the same as that of the first arm 20. That is, the second arm includes the link 21, a link 62 connected to the link 21 via a joint 72 and a joint 73, a link 63 connected to the link 62 via a joint 74 and a joint 75, a link 64 connected to the link 63 via a joint 76 and a joint 77, and a link 65 connected to the link 64 via a joint 78. Additionally, motors 72m to 78m, and angle sensors 72s to 78s to be described below are built in the joints 72 to 78. Moreover, the gyro sensor 30 is attached to the link 21, the gyro sensor 31 is attached to the link 25 at the tip of the first arm 20, and a gyro sensor 33 is attached to the link 65 at the tip of the second arm 70. Additionally, similar to the gyro sensor 30 of the aforementioned first embodiment, the gyro sensor 30 of the third embodiment is also attached so that the Z-axis of the gyro sensor 30 has the same direction as the rotational axis of the joint 41. In addition, the joints 72 to 78 included in the second arm 70 of the third embodiment correspond to a “second joint portion” in the invention. Additionally, the gyro sensor 33 attached to the tip of the second arm 70 corresponds to a “second inertial sensor” in the invention. Moreover, the angle sensors 72s to 78s that detect the angles of the joints 72 to 78 correspond to a “second angle detection unit” in the invention.

Moreover, even in the robot 4 of the third embodiment, the controller 50 is built in the base 10, and the motors 42m to 48m and the angle sensors 42s to 48s attached to the joints 42 to 48 of the first arm 20, the motors 72m to 78m and the angle sensors 72s to 78s, of the second arm 70, the motor 41m and the angle sensor 41s on the base 10 side, and the gyro sensors 30, 31, and 33 are connected to the controller 50. Additionally, in the third embodiment, it is possible to move the base 10 by means of wheels 95, and it is possible to fix the base 10 to the ground with stoppers 96 after being moved to a desired position. In addition, even in the third embodiment, the motors 42m to 48m attached to the first arm 20 may be referred to as “first motors”, and the base-side motor 41m may be referred to as a “base-side motor.” Additionally, the motors 72m to 78m attached to the second arm 70 may be referred to as “second motors”.

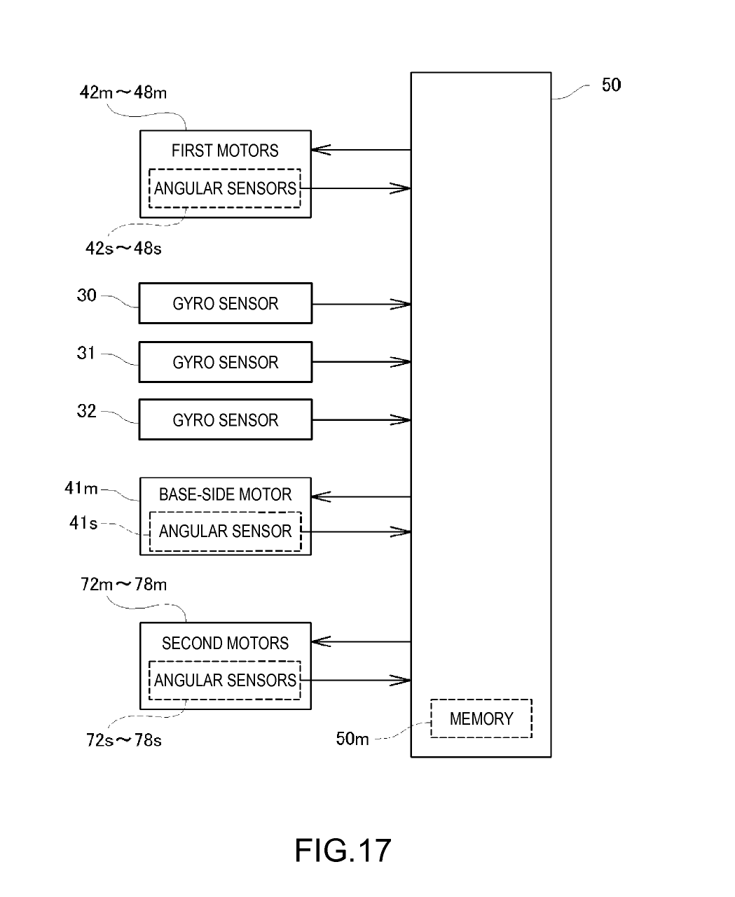

FIG. 17 is an explanatory view of the connection relationship between the motors 41m to 48m and 72m to 78m, the angle sensors 41s to 48s and 72s to 78s, and the gyro sensors 30, 31, and 33 provided at the respective joints 41 to 48 and 72 to 78 of the robot 4 of the third embodiment, and the controller 50. Even in the third embodiment, the outputs of the angle sensors 41s to 48s and 72s to 78s and the outputs of the gyro sensors 30, 31, and 33 are input to the controller 50. The controller 50 controls the operation of the motors 41m to 48m and 72m to 78m mounted on the respective joints 41 to 48 and 72 to 78 on the basis of these outputs.

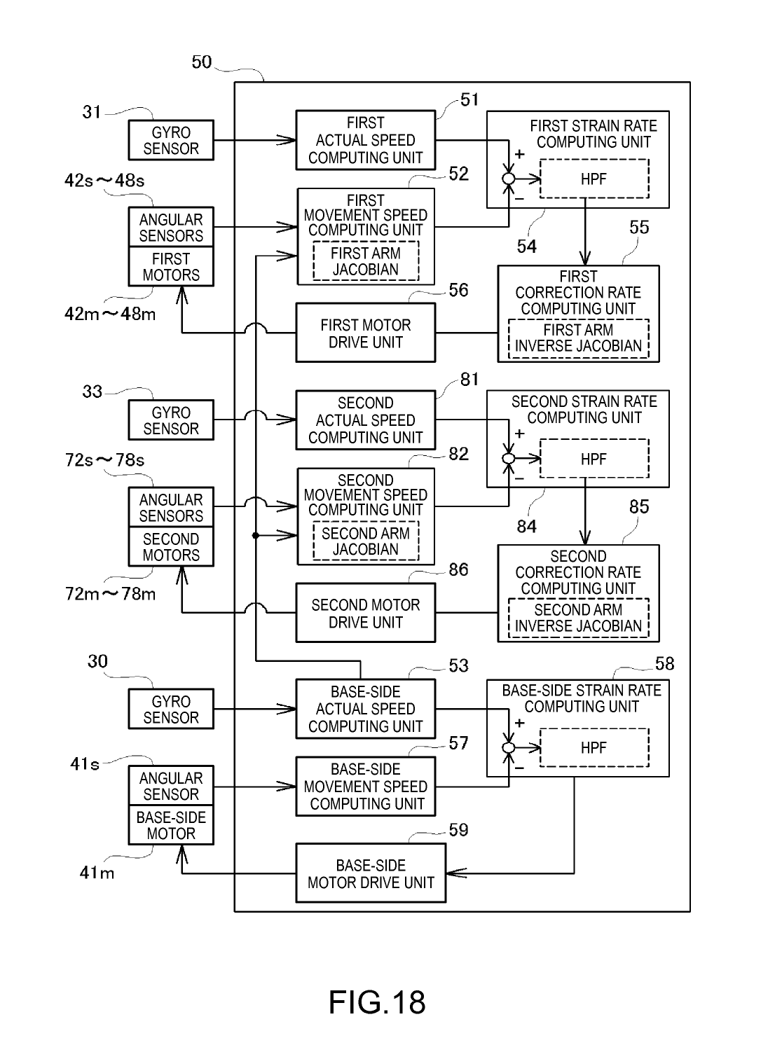

FIG. 18 is a block diagram conceptually illustrating an internal configuration of the controller 50 of the third embodiment. The configuration for controlling the base-side motor 41m and the first motors (motors 42m to 48m) is the same as the configuration of the first embodiment mentioned above with reference to FIG. 3. That is, the aforementioned predetermined computation is performed on the outputs of the gyro sensor 30 and the angle sensor 41s in the base-side actual speed computing unit 53, the base-side movement speed computing unit 57, the base-side strain rate computing unit 58, and the base-side motor drive unit 59, and the base-side motor 41m is controlled on the basis of the results. Additionally, with respect to the first motors (motors 42m to 48m), the aforementioned predetermined computation is performed on the computation results (the actual speed of the link 21) of the gyro sensor 31, the angle sensors 42s to 48s, and the base-side actual speed computing unit 53, in the first actual speed computing unit 51, the first movement speed computing unit 52, the first strain rate computing unit 54, the first correction rate computing unit 55, and the first motor drive unit 56, and the operation of the first motors (motors 42m to 48m) is controlled on the basis of the results.

Additionally, as described above, the second arm 70 is mounted on the robot 4 of the third embodiment. In order to correspond to this, the same configuration for controlling the first arm 20 is provided at the controller 50 in order to control the configuration for controlling the second motors (motors 72m to 78m) of the second arm 70. That is, the controller includes a second actual speed computing unit 81 corresponding to the first actual speed computing unit 51 of the first arm 20, a second movement speed computing unit 82 corresponding to the first movement speed computing unit 52, a second strain rate computing unit 84 corresponding to the first strain rate computing unit 54, a second correction rate computing unit 85 corresponding to the first correction rate computing unit 55, and a second motor drive unit 86 corresponding to the first motor drive unit 56. A second arm Jacobian of the second movement speed computing unit 82 among these units and a second inverse Jacobian of the second correction rate computing unit 85 among these units are determined in accordance with the dimensions and deformation easiness of the respective links 62 to 64 and the joints 72 to 78 of the second arm 70, similar to the first arm Jacobian J1 and the first arm inverse Jacobian RJ1.

The operation of the second motors (motors 72m to 78m) is controlled by performing the same processing as the first embodiment on the computation results (the actual speed of the link 21) of the gyro sensor 33, the angle sensors 72s to 78s, and the base-side actual speed computing unit 53, in the second actual speed computing unit 81, the second movement speed computing unit 82, the second strain rate computing unit 84, the second correction rate computing unit 85, and the second motor drive unit 86. In addition, in the third embodiment, an angular velocity obtained from the output of the gyro sensor 33 corresponds to a “second actual speed” in the invention, and an angular velocity obtained using the second arm Jacobian corresponds to a “second movement speed” in the invention.

If this is the case, the vibration of the second arm 70 can also be suppressed similar to the first arm 20. As a result, since the vibration of the tip of the second arm 70 can also be suppressed, it is possible to rapidly start work after the hand portion attached to the tip of the second arm 70 is moved to a target position.

Although various embodiments have been described above, the invention is not limited to the above embodiment, and can be carried out in various aspects without departing from the scope thereof. For example, the above-described third embodiment has been described so that the two arms including the first arm 20 and the second arm 70 are connected in parallel. However, it is also possible to connect three or more arms in parallel.

The entire disclosure of Japanese Patent Application No. 2013-225055, filed Oct. 30, 2013 is expressly incorporated by reference herein.

What is claimed is:

1. A robot comprising:
a base;
a first arm that is rotatably provided with respect to the base via a base joint portion and has a first joint portion including a plurality of joints;
a base-side inertial sensor that is provided closer to a tip side of the first arm than the base joint portion and closer to a base side of the first arm than the first joint portion and detects an inertial force;
a first inertial sensor that is provided closer to the tip side of the first arm than the first joint portion and detects an inertial force; and
a controller that controls the first joint portion on the basis of a base-side inertial force detected by the base-side inertial sensor and a first inertial force detected by the first inertial sensor.

2. The robot according to claim 1,
wherein the base-side inertial sensor is a sensor that detects the base-side inertial force corresponding to an angular velocity,
wherein the first inertial sensor is a sensor that detects the first inertial force corresponding to an angular velocity,
wherein a first angle detection unit is provided at the plurality of joints included in the first joint portion of the first arm to detect the angles of the plurality of joints,
wherein the controller includes:
a base-side actual speed computing unit that computes a base-side actual speed that is an actual speed of the first arm on the base side, on the basis of the base-side inertial force;
a first actual speed computing unit that computes a first actual speed that is an actual speed of the first arm on the tip side, on the basis of the first inertial force; and
a first movement speed computing unit that computes a first movement speed that is a movement speed of the first arm on the tip side, on the basis of change rates of the angles of the plurality of joints obtained by the first angle detection unit, and the base-side actual speed, and
wherein the first joint portion of the first arm is controlled on the basis of a deviation between the first actual speed and the first movement speed.

3. The robot according to claim 2,
wherein the controller further includes:
a first strain rate computing unit that computes a first strain rate that is a strain rate in the first joint portion on the basis of the deviation between the first actual speed and the first movement speed, and
wherein the first joint portion of the first arm is controlled on the basis of the angles of the plurality of joints obtained by the first angle detection unit and the first strain rate.

4. The robot according to claim 3,
wherein the first strain rate computing unit computes the first strain rate by extracting fluctuation components included in the deviation of the first actual speed and the first movement speed.

5. The robot according to claim 2,
wherein the base joint portion includes at least one joint,
wherein a base-side angle detection unit is provided to detect the angle of the joint included in the base joint portion,
wherein the controller further includes:
a base-side movement speed computing unit that computes a base-side movement speed that is a movement speed of the first arm on the base side, on the basis of a change rate of the angle of the joint obtained by the base-side angle detection unit, and
wherein the base joint portion is controlled on the basis of the deviation between the base-side actual speed and the base-side movement speed.

6. The robot according to claim 2, further comprising:
a second arm that is rotatably provided at the base via the base joint portion and has a second joint portion including a plurality of joints; and
a second inertial sensor that is provided closer to the tip side of the second arm than the second joint portion and detects an inertial force,
wherein the controller controls the second joint portion on the basis of a base-side inertial force detected by the base-side inertial sensor and a second inertial force detected by the second inertial sensor.

7. The robot according to claim 6,
wherein the second inertial sensor is a sensor that detects the second inertial force corresponding to an angular velocity,
wherein a second angle detection unit is provided at the plurality of joints included in the second joint portion of the second arm to detect the angles of the plurality of joints,
wherein the controller further includes:
a second actual speed computing unit that computes a second actual speed that is an actual speed of the second arm on the tip side, on the basis of the second inertial force; and
a second movement speed computing unit that computes a second movement speed that is a movement speed of the second arm on the tip side, on the basis of change rates of the angles of the plurality of joints obtained by the second angle detection unit, and the base-side actual speed, and
wherein the second joint portion is controlled on the basis of a deviation between the second actual speed and the second movement speed.

8. A control device for a robot including a first arm that is rotatably provided with respect to a base via a base joint portion and has a first joint portion including a plurality of joints, the control device comprising:
a base-side inertial sensor that is provided closer to a tip side of the first arm than the base joint portion and closer to a base side of the first arm than the first joint portion and detects an inertial force; and
a first inertial sensor that is provided closer to the tip side of the first arm than the first joint portion and detects an inertial force,
wherein the control device controls the first joint portion on the basis of a base-side inertial force detected by the base-side inertial sensor and a first inertial force detected by the first inertial sensor.

9. A robot system comprising:
a robot; and
a control device that controls the robot,
wherein the robot includes:
a base;
a first arm that is rotatably provided with respect to the base via a base joint portion and has a first joint portion including a plurality of joints;
a base-side inertial sensor that is provided closer to a tip side of the first arm than the base joint portion and closer to a base side of the first arm than the first joint portion and detects an inertial force; and
a first inertial sensor that is provided closer to the tip side of the first arm than the first joint portion and detects an inertial force, and
wherein the control device is a control device that controls the first joint portion on the basis of a base-side inertial force detected by the base-side inertial sensor and a first inertial force detected by the first inertial sensor.
